(19) United States
(12) Patent Application Publication
(10) Pub. No.: US 2017/0116801 A1
(43) Pub. Date: Apr. 27, 2017

(54) ACCESS CONTROL DEVICE

(71) Applicant: PAXTON ACCESS LIMITED, Brighton (GB)

(72) Inventor: Aaron Hallett, Brighton (GB)

(21) Appl. No.: 15/332,731

(22) Filed: Oct. 24, 2016

(30) Foreign Application Priority Data
Oct. 27, 2015 (GB) 1518966.5

(51) Int. Cl. G07C 9/00; E05B 15/16; E05B 9/08; E05B 17/00; E05B 47/00

(52) U.S. Cl. CPC G07C 9/00309; E05B 17/0075; E05B 47/00; E05B 9/08; E05B 15/16

(57) ABSTRACT

An access control device 12 comprising: a locking mechanism 21 for a moveable barrier 11, the moveable barrier having a first side and a second side, the locking mechanism 10 having a locked and an unlocked state; a first locking and/or user interface component 21 for positioning on the first side of the moveable barrier; a second locking and/or user interface component 16 for positioning on the second side of the moveable barrier; and a fixing member 14 54 for extending through a barrier member and for securing the first and second locking and/or user interface components to the barrier member; wherein the fixing member is operable to transmit data signals between the locking and/or user interface components on opposite sides of the moveable barrier. There is also an access control method provided.

The present invention generally relates to electrical signal transmission and, more particularly, to transferring electrical data signals from one component to another.

Electro-mechanical and electronic access control devices, commonly referred to as “locks” need to pass electrical signal data between electrical components to operate and to allow the decoding of inputs caused by persons attempting access and also to provide motive force for initiating unlocking.

The present invention may provide a new way of electrically passing data signals between two electrical components without using traditional cable or wires.

The present invention may eliminate the need to resort to data transmission cables, may increase lock durability and increase ease of installation by making data signal connection transparent to the lock installer.

### SUMMARY OF THE INVENTION

Aspects of the invention are set out in the independent claim and preferred features are set out in the dependent claims.

According to an aspect of the present invention, there is provided an access control device comprising:

a locking mechanism for a moveable barrier, the moveable barrier having a first side and a second side, the locking mechanism having a locked and an unlocked state;

a first locking and/or user interface component for positioning on the first side of the moveable barrier;

a second locking and/or user interface component for positioning on the second side of the moveable barrier; and

a fixing member for extending through a barrier member and for securing the first and second locking and/or user interface components to the barrier member;

wherein the fixing member is operable to transmit data signals between the locking and/or user interface components on opposite sides of the moveable barrier.

Access control units generally comprise one or more user interfaces and one or more locking components provided at access points such as doors or other moveable barriers (a moveable barrier may comprise, but is not limited to, sliding, floating or hinged doors or gates). Generally the user interface and locking components will communicate, for example so that a locking component may control access in response to signals from a user interface, or so that the status of the locking mechanism may be displayed at a user interface. The user interface and locking components may be attached to the moveable barrier (e.g. door/gate) or they may be mounted on a wall, door surround, or other stationary structural member adjacent to the moveable barrier. The term “barrier member” is intended to cover the moveable barrier itself or a stationary or other structural member associated with the moveable barrier (e.g. a door surround or adjacent wall). Often the user interface and locking components will be positioned on opposing sides of the moveable barrier. For example it is sometimes preferred to install a locking control unit on the inside (“secure” side), of the moveable barrier to prevent vandalism, to allow easier access for maintenance and/or to improve ease of communication between the locking component and a central access control server. However, it is usually necessary to place a user interface on the outside (“non-secure” side) of the moveable barrier where users can present access credentials to open the moveable barrier. One reliable means of fixing the locking and interface components at the access point is by using a fixing member passing through a barrier member and coupled to each component. By providing a fixing member through which data signals can be transmitted, additional holes or openings for data transmission need not be made in the barrier member. Advantageously, reduction in the number of holes or openings in the moveable barrier or other barrier member may improve the resistance to fire, reduce the complexity of installation of the access control device (including making locks more easily backwards-compatible) and/or increase lock durability. It is further desirable to reduce the number of holes or openings made at the access point because in certain jurisdictions the fire rating depends on the number of holes made through a door (the more holes, the lower the fire rating).

The first locking and/or user interface component may be a user interface component;

the second locking and/or user interface component may be a locking component comprising an actuating control unit operable to control the locking mechanism between the locked state and the unlocked state and to communicate with the user interface unit.

The fixing member may be electrically conductive. By providing a fixing member which is electrically conductive it is possible to send electrical data signals between the user interface and actuating control units.

The data signals through the fixing member may be electrical signals. Electrical signals are an efficient means of data transfer.

The access control device may further comprise at least one insulating cap for positioning on an end of the fixing member By insulating the end of the electrically conductive fixing member with an electrically insulating cap, the safety of the device may be improved e.g. by preventing transmission of electricity to the exterior of the device where it may give a user an electric shock. It may be advantageous to install an insulating cap at one or both ends of the fixing member.

The data signals through the fixing member may be optical signals. Optical signals may provide rapid and efficient data transfer.

The fixing member may comprise an optical fibre. Optical fibres may prevent loss in optical communications.

The fixing member may be arranged to provide a biasing force to secure the components to the barrier member. By providing a fixing member that passes through a barrier member (e.g. a door or adjacent wall) and produces a force for clamping the units against either side of the barrier member, it may be possible to achieve a better connection between the fixing member and each of the units, even when the thickness of the barrier member fluctuates. This may improve the quality of data transmission.

The access control device may further comprise at least one compression spring arranged to provide a biasing force to secure the components to the barrier member. By providing a compression spring which produces a force for clamping the units against either side of the barrier member, it may be possible to achieve better contact between the fixing member and each of the units, even when the thickness of the barrier member fluctuates. This may improve the quality of data transmission.

The fixing member may be operable to transmit power. By providing a fixing member to secure the components to the barrier member and which can also transmit power, it is possible to provide a power source on only one side of the moveable barrier, but still supply power to both components, without making additional openings or holes in the barrier member. The power source would normally be located on the second (secure) side, along with the actuating control unit, to prevent tampering/vandalism and allow easier maintenance/replacement of the power source.

The access control device may further comprise one or more further fixing members for extending through the barrier member. By providing at least one further fixing member the access control device may be more securely attached to the barrier member. This may be particularly advantageous when a handle is provided and a user may put a turning force, or torque, on the access control device and a further fixing member may prevent the device rotating about the first fixing member. It may be important to ensure access control devices and locking mechanisms can withstand a certain amount of torque for safety and security reasons. For example, the fixing members may be operable to withstand 50 Nm torque, or preferably 60 Nm torque.

At least one further fixing member may be operable to transmit power. By providing a fixing member to secure the units or components on barrier member and which can also transmit power, it is possible to provide a power source on only one side of the moveable barrier, but still supply power to both components, without making additional openings or holes in the barrier member. The power source would normally be located on the second (secure) side, along with the actuating control unit, to prevent tampering/vandalism. By providing two fixing members, one of which transmits power, and the other data, it may be possible to transfer both power and data signals through the barrier member while reducing the interference of the power supply with the data signal.

The fixing member may be selected from the group comprising: screws; bolts; nails; locating pins; and electrically conductive glue. There are several possible types of fixing member, each of which may provide advantages.

The fixing member may comprise a multi-core cable. By providing a multi-core cable within the fixing member it is possible to transfer data flexibly. For example, there may be separate cores for data in each direction. Alternatively, or in addition, it may be possible to transfer both data signals and power supply via the same fixing member, reducing the number of holes or openings that must be made in the barrier member.

The locking component may be operable to control the state of the locking mechanism based on control logic and a user input received at the user interface unit. By providing control logic it may be possible to make a complex access control decision based on a plurality of different parameters (e.g. the identity/classification of the user, the time of day, the security state of the building).

The locking component may be operable to store control logic. By providing control logic at the actuating control unit it is possible to quickly and efficiently determine whether or not access should be granted.

The access control device may further comprise a communication interface for communicating with a remote data store, the remote data store comprising control logic. By providing control logic on a remote data store it may be possible to update access control logic quickly and efficiently (e.g. at a central access control server) and ensure the most up-to-date control settings are used. The communication interface may be wired or wireless, however wireless is preferred. When the communication is wireless, the access control device would also comprise a wireless receiver or transceiver for communicating with the remote data store.

The access control device may further comprise at least one housing member for housing one of the locking and/or user interface components. The access control device may further comprise:

a first housing member for housing the first locking and/or user interface component and for fixing onto the first side of the barrier member;

a second housing member for housing the second locking and/or user interface component and for fixing onto the second side of the barrier member. By providing housing for the units it may be possible to provide better protection for the control units and ensure they are more secure.

The user interface unit may be operable to receive a user credential. By providing a user interface which may receive a user credential it is possible to allow access based on this credential. Data indicative of the user credential could be transmitted from the user interface unit to the actuating control unit via the fixing member. Then a determination of whether access should be allowed may be made.

The user credential may comprise one or more of: an identifier stored on an access card or fob; a biometric identifier; and an access code.

The user interface unit may comprise at least one of: a magnetic card, an integrated circuit, IC, card or a smart card reader; a fob reader; a biometric reader; and a keypad. The credential and reader may take different forms, each of which may be particularly suited to different applications.

The user interface unit may be operable to display information relating to the access control device. By providing a user interface which may display data it is possible to provide a user with information about the access control device. The data could comprise information such as whether the locking mechanism is locked or unlocked, whether access has been denied and/or the status of a battery. The display means could comprise one or more LEDs or lights, or could comprise a display screen. Data or information for display may be transferred/sent from the actuating control unit to the user interface unit through the fixing member.

According to another aspect of the present invention, there is provided an access control method comprising the steps of:

receiving a user input at a user interface component secured on a first side of a barrier member for a moveable barrier;

sending a signal indicative of the received user input from the user interface component to a locking component secured on a second side of the barrier member, wherein the signal is passed through a fixing member extending through the barrier member for securing the first user interface component and locking component to the barrier member;

determining an access control action based on the received user input;

upon determining that access should be allowed, switching a locking mechanism associated with the moveable barrier member from a locked state to an unlocked state.

By sending a signal from a user interface on one side of a moveable barrier to a control unit on the other side of the barrier through a fixing member which secures both units to a barrier member, it is possible to provide a quick and easy method of transferring data without creating additional holes or openings in the barrier member. This may have several advantages, as structural members such as walls and moving members such as doors may have greater structural integrity when they have fewer holes or openings, fire safety ratings for doors may be improved when there are fewer holes or openings in the door, installation may be quicker and easier when fewer holes must be made and access control devices may be made backwards compatible.

The access control method may further comprise the steps of: sending a signal indicative of a status of the locking mechanism from the locking component to the user interface component, wherein the signal is passed through the fixing member. By providing a signal from the locking component to the user interface component it may be possible to provide status information to the user, such as whether an access attempt has been successful, or whether the locking mechanism is currently locked or unlocked. For example the user interface component may display information by an LED indicator or on a display screen. Alternatively the user interface may make a sound indicative of a successful or failed access attempt.

The access control method may further comprise the steps of: displaying information indicative of the status of the locking mechanism at the user interface component. By displaying information at the user interface unit it may be possible to inform a user of the state of the access device, such as whether an access attempt has been successful or unsuccessful. For example the user interface unit may display information by an LED indicator or on a display screen.

According to another aspect of the present invention, there is provided an access control device comprising:

a locking mechanism for a moveable barrier, the moveable barrier having a first side and a second side, the locking mechanism having a locked state and an unlocked state;

a locking and/or user interface component for positioning on the first side of the moveable barrier;

at least one rigid non-fixing member for extending through a barrier member, wherein the rigid non-fixing member is operable to conduct data and/or power through the barrier member.

Access control systems generally comprise a user interface unit positioned at the outside, or unsecure side, of an access point. By providing a rigid non-fixing member for transmitting data and/or power through the structural member it is possible to place power sources and/or computer processors (such as controllers) on the inside, or secure side, of the access point (e.g. to avoid damage or vandalism and/or to allow easier maintenance).

The access control device may further comprise:

a first handle for positioning on the first side of the barrier member; and

wherein the rigid non-fixing member is a spindle for passing through the barrier member and for coupling to the first handle. By providing the rigid non-fixing member in the form of a spindle, or handle shaft, which can transmit data and/or power, it may be possible to reduce the number of holes or openings that need to be made in the barrier member (e.g. door). Advantageously, this may improve the fire rating of a barrier, reduce the complexity of installation of the access control device (including making locks more easily backwards-compatible) and/or increase lock durability.

The access control device may further comprise:

a second handle for positioning on the second side of the barrier member; and

wherein the spindle is operable to be coupled to the second handle. By providing a second handle on the second side of the barrier member (e.g. door or gate or wall adjacent to door) which is also coupled to the spindle, it is possible to provide access from both sides of the access point. In one example, the second handle may always be operable to allow access (e.g. by allowing retraction of a bolt locking a door). In another example, the second handle may only allow access when a user input has been accepted on the second side of the access point. This may be input via a second user interface unit. For example, this may be pressing an “exit” button, or providing a user credential that needs to be verified, such as an access code, biometric identifier or smart card.

The access control device may further comprise:

an actuating control unit operable to control the locking mechanism between the locked state and the unlocked state and to communicate with the user interface unit, the actuating control unit for positioning on a second side of the moveable barrier;

and wherein the actuating control unit and user interface unit are operable to communicate by sending data signals through the rigid non-fixing member.

The access control device may further comprise:

a power source for positioning on a second side of the barrier member;

wherein the rigid non-fixing member is operable to conduct power from the power source on the second side of the barrier member to the user interface unit on the first side of the barrier member.

The rigid non-fixing member may be a hollow tube extending through the barrier member and may be operable to conduct data and/or power through the barrier member via one or more wires extending through the tube. When the non-fixing member is a rigid hollow tube, it is possible to pass wires through the barrier member which may transmit data signals and/or power. Passing data and/or power through a hollow non-fixing member such as a spindle, or along grooves in the spindle may alleviate problems associated with the mechanical fasteners which can degrade over time, particularly in humid climates. Where power is to be transferred, two wires (or a multicore cable) may be preferred in order to complete the electrical circuit. Alternatively, one wire for a first electrical power connection may pass through the rigid non-fixing member and a second electrical connection may take an alternative route through the barrier member (i.e. structural/door/moving member) e.g. through a fixing member for fixing the access control device to the barrier member. Where data is to be transferred, multiple wires or only a single wire may be used. It may also be possible to transfer both data and power with a single signal over a single interface (e.g. using 1-wire® technology).

The rigid non-fixing member may be a hollow tube extending through the barrier member and may be operable to conduct data through the barrier member via optical signals. Optical signals can provide rapid and efficient data transfer. The optical signals may be provided by e.g. lasers or LEDs and detectors.

An optical fibre may be provided within the hollow tube, said optical fibre may be operable to conduct optical data signals through the barrier member. Optical fibres can prevent loss in optical communications.

The rigid non-fixing member may be a solid electrically conductive member. By providing a solid, rigid, non-fixing member for passing through the barrier member and for conducting data and/or power it is possible to provide an access control device that can be easily installed and can conduct data and/or power by electrical currents.

The rigid non-fixing member may have one or more grooves on its outer surface and may be operable to conduct data and/or power through the barrier member via one or more wires located within the grooves. By providing a rigid non-fixing member with a grooved outer surface, it is possible to provide wire(s) for transmitting data and/or power, which pass through the same hole or aperture in the barrier member as the rigid non-fixing member. Advantageously, the number of holes or openings in the barrier member can be reduced, which may improve the fire rating of a door, improve durability and/or increase ease of installation (including by allowing backwards-compatibility e.g. a grooved, spindle provided with wires may be able to be installed the same aperture in a door as a previously installed spindle from another design.

Reference will now be made to the accompanying drawings, in which:

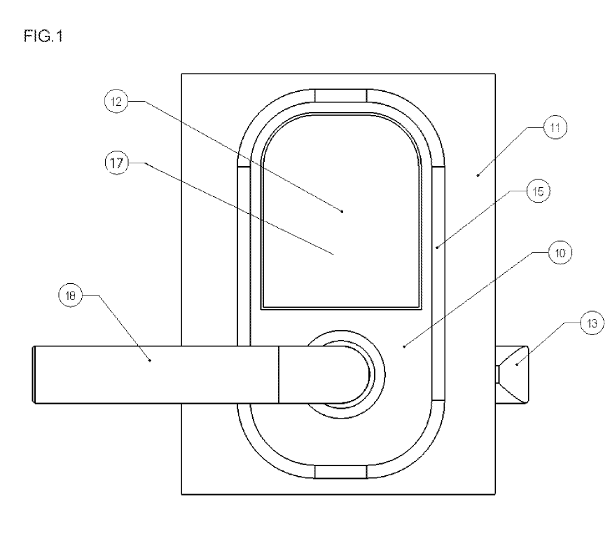

FIG. 1 is a front elevation view of a lock mounted to a door and including an electronic access control device;

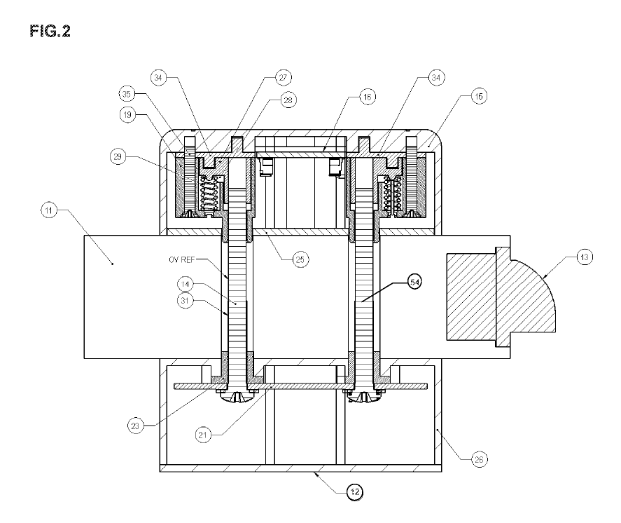

FIG. 2 is a bottom cross-sectional view of the lock shown in FIG. 1;

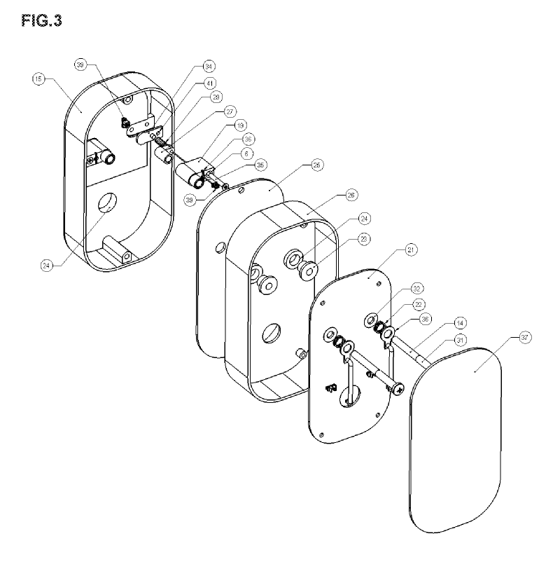

FIG. 3 is an exploded perspective view of the electronic access control device of the lock shown in FIG. 1

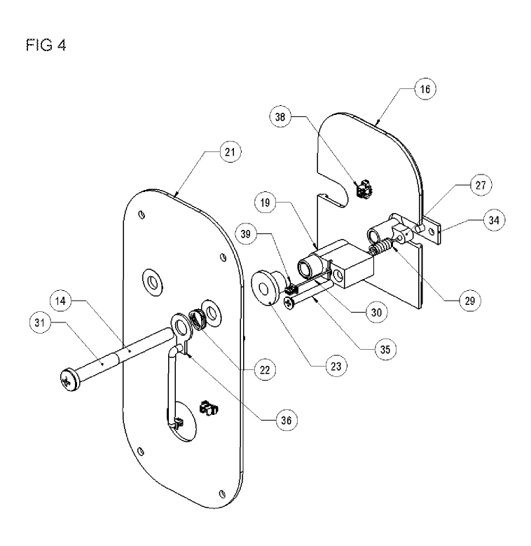

FIG. 4 is an exploded perspective view of one half of the outside signal transmission components of the electronic access control device.

### DESCRIPTION OF THE EMBODIMENTS

In one embodiment, one component (or unit) of an access control device is required to be mechanically clamped (or secured) to each side of a door at an access point. Generally a user interface unit is positioned on one side of the door for receiving user inputs and an actuating control unit for controlling access (i.e. by locking or unlocking the door) is placed on the other side of the door. Fixing holes drilled into the door potentially weaken the door's fire protection rating. Removing the need for further holes being drilled into a door for passing of cables may allow the fire rating to stay intact without negative impact.

The term ‘door’ is herein intended to mean any surface upon which an access control device can be mounted. A moveable barrier could relate to a door or other moving member, for example, a gate. The access control device may also be clamped or secured to a barrier member at an access point (e.g. a wall adjacent to an access point or door). Again, a user interface unit and an actuating control unit would normally be placed on opposite sides of the barrier member.

FIG. 1 shows an access control device 12 mounted to a door 11 for selectively preventing and allowing opening of the door 11. The electronic access control device 12 comprises a lock 10 having a latch bolt 13, which can move between a locked and an unlocked position to restrict or allow access through the door 11. The access control device is adapted to control the operation of the latch bolt 13.

FIG. 2 shows a cross-sectional view of the access control device 12 of FIG. 1 and FIG. 3 is an exploded perspective view of the electronic access control device 12 FIG. 1. As shown in FIGS. 2 and 3, the access control device 12 comprises an actuating control unit 21 positioned on the inner, or secure, side of the door 11 and a user interface unit 16 positioned on the outer, or unsecure, side of the door 11. The user interface unit 16 has an outdoor housing component 15 and the actuating control unit 21 has an indoor housing component 26 adapted to be respectively mounted on the outer and inner side of the door 11. The housing components may make the units more secure and/or provide protection for the units (e.g. weatherproofing if one or more sides of the door are outside).

The user interface unit 16 (FIG. 2) is operable to receive an input from a user, such as a user credential. In this embodiment, the user interface unit 16 includes a circuit board operatively associated to a Radio Frequency Interface (RFI) badge reader 17 (FIG. 1) for receiving a user input from a Radio Frequency (RF) access device. When a user presents such an access device to the RFI reader 17, activation and initialisation data may be transmitted to the user interface unit 16. This may include a credential or user identifier. It is noted that an RFI reader is just one type of suitable user interface. Other examples include readers for Smart cards, Integrated Circuit (IC) cards, magnetic stripe cards, fobs, or Bluetooth devices. Alternatively, a biometric reader for sensing a user's biometric characteristics (e.g. for iris, fingerprint or voice recognition) could be used. A keypad for allowing a user to input a password or access code is another alternative. In some embodiments, the user interface could comprise more than one type of reader.

The user interface unit may also be operable to display information (such as lock status) to a user. This could comprise one or more lights or LEDs (e.g. for indicating lock status information). Alternatively (or in addition), the user interface may comprise a display screen which could display more detailed information or commands. (E.g. instructing a user to present a credential, or informing a user that a credential is invalid or that access is denied).

The actuating control unit 21 is operational for allowing or preventing retraction of latch bolt 13 by manual operation of a handle 18 (FIG. 1). The actuating control unit 21 may include a logic store of control logic for determining whether to allow or deny a user access based on a user input (such as a credential). Control logic may also be stored remotely (e.g. at a central access control server). Each time a user inputs a credential the access control device 12 may be required to communicate with the remote store to determine whether access should be allowed. Alternatively the remote store may periodically communicate with the access control device 12 to update the logic store of the actuating control unit 21. When communication with a remote store is required, a wired or wireless connection may be used. When the access control unit is fixed to a moving door wireless communication is preferred.

As shown in FIG. 3, the outdoor housing 15 has a front wall with a circular opening 24 for receiving the drive shaft which is connected to the handle 18 for allowing operation of the latch bolt 13. A back plate 25 is provided for closing the back face of the outdoor housing component 15 while allowing the outdoor housing component 15 to be mounted to the outside surface of the door 11. The back plate 25 is preferably removably secured to the outdoor housing component 15 by means of mechanical fasteners, such as screws (not shown).

At least one source of power is provided for powering the user interface unit 16 and the actuating control unit 21. The source of power can, for instance, be provided in the form of battery (not shown) (FIG. 2) housed in the casing 15 or 26. Generally it is preferred to provide the power source on the inner, or secure, side of the door 11, as this is more secure and may protect it somewhat (e.g. from vandals or unauthorised persons).

A first mechanical fastener 14 is provided for fixing the user interface unit 16 and the actuating control unit 21 onto the door 11. The first mechanical fastener 14 may be e.g. a bolt or a screw, and is used to clamp the outdoor and indoor housing components 15 and 26 together against opposite sides of the door 11. Data signals are transmitted between the user interface unit 16 and the actuating control unit 21 through the thickness of the door 11 via the first mechanical fastener 14. Data signals may comprise, for example, details of user credentials presented at the user interface unit 16 and transmitted to the actuating control unit 21. Where the user interface unit 16 is operable to display information, data signals may also be transmitted from the actuating control unit 21 to the user interface unit 16.

A second mechanical fastener 54 for fixing the user interface unit 16 and the actuating control unit 21 onto the door 11 is also provided. One of the mechanical fasteners 14, 54 may be operable to transmit electrical power from the source of power to one of the units. Normally the source of power would be on the inner, secure, side of the door and power would be supplied to the user interface unit 16 via one of the mechanical fasteners. In a preferred embodiment, electrical power supply is through the second mechanical fastener 54, as this prevents the power supply interfering with the data signals travelling on the first mechanical fastener 14.

In accordance with a preferred embodiment, the first mechanical fastener 14 is an electrically conductive bolt and electronic data signals are generated from the electronic control units 16 and 21 and transmitted to the first mechanical fastener 14 through a standard electrical connector, e.g. ring lug 36 (electrical crimp lug), which is spring loaded against the underside of the bolt head by a wave spring 22. This advantageously guarantees intimate electrical contact between the bolt head and lug 36. The second mechanical fastener 54 may also be similarly constructed.

As can be appreciated from FIG. 2, the bolt head and lug 36 can move in and out to compensate for expansion and contraction of the door 11. The bolt 14 is insulated by terminal block 19 and insulation cap 23 at both surface interfaces and also separately insulated along its length by an insulating coating or a heat shrink tubing 31. The terminal blocks 19 and 23 are made from an insulating material, such as plastic. The bolt 14 extends through a hole 24 defined in the indoor housing component 26. The inside insulator cap 23 is received in the recess 24 which is adapted to receive the bolt 14 to prevent power transmission from the bolt 14 to the indoor housing component 26. This prevents an electrical current being transferred to a user.

The bolt 14 extends through the indoor housing component 15, through the thickness of the door 11 and into the outdoor housing component 26, thereby allowing data signals to pass from the inner side of the door to the outer side thereof. The bolt 14 is threadably engaged at the leading end thereof (opposite its head) with the inner threads of a threaded contact sleeve 27 received in a corresponding L-shaped hole 28 (FIG. 2) defined in the outside terminal block 19. According to a preferred embodiment, the internally threaded sleeve 27 is made from brass. As an added precaution to ensure good electrical and mechanical connection between the outside bolt end and the sleeve 27, the sleeve 27 is threaded with a special thread form that provides more intimate electrical contact and resists loosening. For instance, known self-locking threads could be used. Alternatively, the sleeve 27 could be slightly deformed to provide the desired thread locking feature. Other types of tensioners are contemplated as well.

The contact sleeve 27 has an integral foot portion projecting at right angles from one end thereof. The sleeve 27 and the foot portion have an L-shape configuration. A compression spring 29 extends between the foot portion and the outside terminal block 19 about a wire 30 (FIG. 4) having a first end in electrical contact with the foot portion. The first end of the wire 30 can be soldered to the foot portion or otherwise connected thereto. Alternatively, the compression spring 29 could act on a washer provided at the first end of the wire 30 to maintain the wire 30 in electrical contact with the foot portion of the sleeve 27. However, the main role of the compression spring 29 is to bias the female threads of the sleeve 27 against the male bolt threads of bolts 14 within the insulated terminal block 19. The wave spring 22 also cooperates with the compression spring 29 to maintain the bolt 14 under tension in both directions in order to further force the contact threads together.

The compression spring 29 in the outside terminal block 19 and wave spring 22 in the inside chassis body 26 act as tensioners to keep the bolt 14 under constant tension to prevent loss of conduction due to vibration, mechanical shock or thermal/mechanical changes in the mounting surfaces. Thus, the bolt 14 is in constant tension, being biased away from both mounting surfaces of the door 11 to ensure good electrical contact even as mounting thickness changes with fluctuations in temperature, humidity, or due to other factors.

The wire 30 extends through a slotted passage 36 defined in the outside terminal block 19 and the second end 39 (FIG. 2) thereof is connected to a connector of the user interface unit 16, thereby allowing power to be transferred from the contact sleeve 19 to the lateral foot portion thereof, the wire 30 and then to the user interface unit 16.

Once assembled, the outside terminal block 19, the contact sleeve 14 and the compression spring 29 are mounted to the outdoor housing component 15 as a single unit by means of a screw 35 extending through a hole 40 defined in the outside terminal block 19. An outside insulator plate 34 is interposed between the outdoor housing component 15 and the contact sleeve 27 to prevent electrical transmission there-between. A hole 41, is defined in the insulator plate 34 for allowing the screw 35 to be threadably engaged in a corresponding hole defined in the outdoor housing component 15.

As shown in FIG. 2, a gap is provided between cover plate 33 and the spring-loaded threaded sleeve 27 to accommodate movement of the sleeve 27 in order to keep tension on the threads of bolt 14.

The ring lug 36, the bolt 14, the contact sleeve 27, and the wire 30 provide one “leg” of the signal data circuit to the electronic control unit 16.

The other V0 reference leg may be provided by the remaining bolts used to fasten the lock 10 to the door 11, e.g. bolt 54 illustrated in FIG. 2, since these typically pass through from one side to the other to fasten the indoor and outdoor housing components 15 and 26 together.

It is understood that the device 12 could be mounted on a doorframe or a wall instead of on door 11. Also, it is understood that the present invention could also be used in applications where data are communicated through bolt 14 independently or in concert with power. Furthermore, it will be readily apparent for a person skilled in the art, that a plurality of such bolts could be used within a single device. Also, it is understood that the electrically conductive bolt could be used for the sole purpose of conducting current without performing other mechanical or physical interconnection functions. It will also be readily apparent to, and understood by, the skilled person, that two bolts are not necessary for any data signal and/or power transfer; just one bolt could be used.

What is claimed is:

1. An access control device comprising:
a locking mechanism for a moveable barrier, the moveable barrier having a first side and a second side, the locking mechanism having a locked and an unlocked state;
a first locking and/or user interface component for positioning on the first side of the moveable barrier;
a second locking and/or user interface component for positioning on the second side of the moveable barrier; and
a fixing member for extending through a barrier member and for securing the first and second locking and/or user interface components to the barrier member;
wherein the fixing member is operable to transmit data signals between the locking and/or user interface components on opposite sides of the moveable barrier.

2. An access control device according to claim 1, wherein:
the first locking and/or user interface component is a user interface component; and
the second locking and/or user interface component is a locking component comprising an actuating control unit operable to control the locking mechanism between the locked state and the unlocked state and to communicate with the user interface unit.

3. An access control device according to claim 1, wherein the fixing member is electrically conductive; and wherein the data signals through the fixing member are electrical signals.

4. (canceled)

5. An access control device according to any preceding claim 1, further comprising at least one insulating cap for positioning on an end of the fixing member.

6. An access control device according to claim 1, wherein the data signals through the fixing member are optical signals, and wherein the fixing member comprises an optical fibre.

7. (canceled)

8. An access control device according to any preceding claim 1, wherein the fixing member is arranged to provide a biasing force to secure the components to the barrier member.

9. An access control device according to any preceding claim 1, further comprising at least one compression spring arranged to provide a biasing force to secure the components to the barrier member.

10. An access control device according to claim 1, wherein the fixing member is operable to transmit power.

11. An access control device according to claim 1, further comprising one or more further fixing members for extending through the barrier member, wherein at least one further fixing member is operable to transmit power.

12-13. (canceled)

14. An access control device according to claim 1, wherein the fixing member comprises a multi-core cable.

15. An access control device according to claim 1, wherein the locking component is operable to control the state of the locking mechanism based on control logic and a user input received at the user interface unit, wherein the locking component is operable to store control logic, and further comprising a communication interface for communicating with a remote data store, the remote data store comprising control logic.

16-19. (canceled)

20. An access control device according to claim 1, wherein the user interface unit is operable to receive a user credential, wherein the user credential comprises one or more of:
an identifier stored on an access card or fob;
a biometric identifier; and
an access code;
wherein the user interface unit comprises at least one of:
a magnetic card, an integrated circuit, IC, card or a smart card reader;
a fob reader;
a biometric reader; and
a keypad.

21-22. (canceled)

23. An access control device according to claim 1, wherein the user interface unit is operable to display information relating to the access control device.

24. An access control method comprising the steps of:
receiving a user input at a user interface component secured on a first side of a barrier member for a moveable barrier;
sending a signal indicative of the received user input from the user interface component to a locking component secured on a second side of the barrier member, wherein the signal is passed through a fixing member extending through the barrier member for securing the first user interface component and locking component to the barrier member;
determining an access control action based on the received user input;
upon determining that access should be allowed, switching a locking mechanism associated with the moveable barrier member from a locked state to an unlocked state.

25. An access control method according to claim 24, further comprising the steps of:
sending a signal indicative of a status of the locking mechanism from the locking component to the user interface component, wherein the signal is passed through the fixing member.

26. (canceled)

27. An access control device comprising:
a locking mechanism for a moveable barrier, the moveable barrier having a first side and a second side, the locking mechanism having a locked state and an unlocked state;
a locking and/or user interface component for positioning on the first side of the moveable barrier;
at least one rigid non-fixing member for extending through a barrier member, wherein the rigid non-fixing member is operable to conduct data and/or power through the barrier member.

28. An access control device according to claim 27, further comprising:
a first handle for positioning on the first side of the barrier member;
wherein the rigid non-fixing member is a spindle for passing through the barrier member and for coupling to the first handle; and
a second handle for positioning on the second side of the barrier member;
wherein the spindle is operable to be coupled to the second handle.

29-30. (canceled)

31. An access control device according to claim 27, further comprising:
a power source for positioning on a second side of the barrier member;
wherein the rigid non-fixing member is operable to conduct power from the power source on the second side of the barrier member to the user interface unit on the first side of the barrier member.

32. An access control device according to claim 27, wherein:
the rigid non-fixing member is a hollow tube extending through the barrier member and is operable to conduct data and/or power through the barrier member via one or more wires extending through the tube.

33. An access control device according to claim 27, wherein:
the rigid non-fixing member is a hollow tube extending through the barrier member and is operable to conduct data through the barrier member via optical signals, and wherein an optical fibre is provided within the hollow tube, said optical fibre operable to conduct optical data signals through the barrier member.

34-38. (canceled)
